(19) United States
(12) Patent Application Publication
(10) Pub. No.: US 2010/0269778 A1
(43) Pub. Date: Oct. 28, 2010

(54) CYLINDER HEAD ASSEMBLY FOR AN INTERNAL COMBUSTION ENGINE AND METHOD OF MAKING THE SAME

(75) Inventors: Pui-Kei Yuen, Rochester Hills, MI (US); David L. Moore, Madison Heights, MI (US)

Correspondence Address: Cantor Colburn LLP-General Motors, 20 Church Street, 22nd Floor, Hartford, CT, 06103, US

(73) Assignee: GM GLOBAL TECHNOLOGY OPERATIONS, INC., Detroit, MI (US)

(21) Appl. No.: 12/428,123

(22) Filed: Apr. 22, 2009

(51) Int. Cl. F02F 1/42; F01L 1/00

(52) U.S. Cl. 123/193.5; 123/188.8

(57) ABSTRACT

A cylinder head for an internal combustion engine comprises a combustion chamber/face, a port opening into the combustion chamber/face and an insert pocket circumferentially disposed about the port and configured to receive a valve seat insert therein. A carbon layer is disposed between the insert pocket and the valve seat insert and is configured to prevent corrosion of the insert pocket caused by exposure to alcohol based fuels such as ethanol.

### FIELD OF THE INVENTION

This invention relates to a cylinder head assembly for an internal combustion engine having a valve seat insert and, more particularly, to a cylinder head assembly, having a valve seat insert, that is resistant to corrosion and a method of making the same.

### BACKGROUND

Valve seat inserts may be installed in the cylinder heads of internal combustion engines to improve durability. Such inserts are often employed in cylinder heads comprised of softer and lighter alloys which may not have the robust strength, hardness, wear and other material characteristics required for high temperature high wear environments. The valve seats are typically press-fitted into an insert pocket in the cylinder head and are often manufactured from a relatively hard, wear-resistant and heat resistant material such as a cast or sintered metal. When installed in the cylinder head, the valve seat inserts are effective to provide a seating surface for the engine's reciprocating valves.

The press-fit mating of the valve seat insert with the cylinder head insert pocket may result in the formation of minute gaps or crevices between the surfaces of the insert and the cylinder head material. During operation of the engine, liquid or fuel may enter these openings and become trapped therein. While the trapped fuel is relatively benign in engines which operate on fuels containing a relatively low percentage of alcohols such as ethanol, it may be corrosive in engines operating on fuels containing a relatively high percentage of alcohols, especially in situations in which the cylinder head is constructed of an aluminum alloy or other light weight, alloyed material.

In engines which utilize fuels containing a relatively high percentage of ethanol (e.g. greater than 15% ethanol), the trapped fuel, ambient water dissolved in the fuel, or both of them, may form and/or promote the formation of corrosive acids or byproducts which may corrode the cylinder head, the inserts, or both, in the areas associated with the valve inserts. Further, these liquids may promote dissimilar metal corrosion through the galvanic effect by serving as an electrolyte in contact with the dissimilar metals of the insert and cylinder head. Over time, such corrosion may affect the durability of the cylinder head and associated valve seats, especially in cylinder heads which are manufactured from an aluminum alloy.

Various methods have been proposed to address corrosion associated with alcohol/ethanol based fuels including coating the cylinder head insert pocket with epoxy or phenolic sealants prior to installation of the valve seat insert. Such materials however, if misapplied during application to other components of the engine or valves, or combusted during operation of the engine, may present potential contamination issues for devices such as oxygen or other sensors and, therefore, must be applied with great care and precision during manufacture of the cylinder head assembly or, should be avoided.

It is therefore desirable to provide a valve seat and cylinder head assembly that is resistant to corrosive activity, especially corrosion which may be caused by or associated with fuels containing alcohols such as ethanol.

### SUMMARY OF THE INVENTION

In one exemplary embodiment of the present invention, a cylinder head assembly for an internal combustion engine comprises a cylinder head having a combustion chamber/face, a port opening into the combustion chamber/face and an insert pocket circumferentially disposed about the port and configured to receive a valve seat insert therein. A carbon layer is disposed between the insert pocket and the valve seat insert and defines a seal/surface modifier therebetween.

In another exemplary embodiment of the present invention, a method of manufacturing a corrosion resistant cylinder head for an internal combustion engine comprises forming a cylinder head having a combustion chamber/face and a port opening into the combustion chamber/face, forming an insert pocket about the port of the cylinder head, forming a valve seat insert, fixing the valve seat insert into the insert pocket and disposing carbon between the valve seat insert and the insert pocket wherein the valve seat insert bears upon the carbon forming a fuel seal/surface modifier between the valve seat insert and the insert pocket.

### BRIEF DESCRIPTION OF THE DRAWINGS

Other objects, features, advantages and details appear, by way of example only, in the following detailed description of the embodiments, the detailed description referring to the drawings in which:

FIG. 1 is a partial view of an exemplary embodiment of a combustion chamber/face of a cylinder head assembly for an internal combustion engine embodying features of the present invention;

FIG. 2 is a sectional view of the cylinder head taken along section 2-2 of FIG. 1; and

FIG. 3 is a perspective view of a valve seat insert shown in FIG. 2; and

### DESCRIPTION OF THE EMBODIMENTS

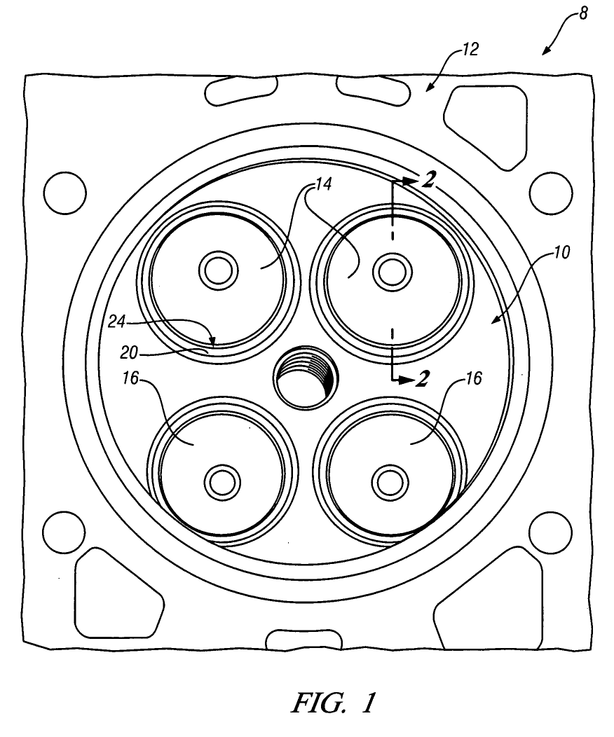

In accordance with an exemplary embodiment of the present invention, illustrated in FIG. 1, a cylinder head assembly 8, for an internal combustion engine (not shown), includes a cylinder head 12 having a combustion chamber 10. The combustion chamber may comprise a number of various configurations depending, in large part, on the particular engine and/or fuel system configuration and, for the purposes of description shall be referred to as a combustion chamber/face 10. The cylinder head includes one or more intake ports 14 through which a fuel/air mixture enters the combustion chamber during operation of the engine. The fuel/air mixture is compressed by a reciprocating piston (not shown) and is combusted in the combustion chamber/face 10. The combustion event drives the reciprocation of the piston and, therefore, the engine. Exhaust ports 16 provide for the exit of the products of combustion from the combustion chamber/face 10.

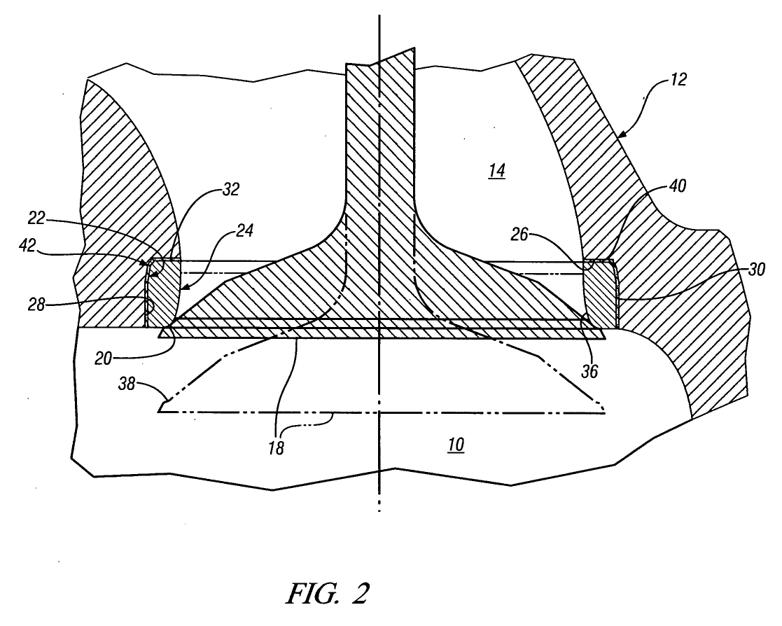

Referring to FIG. 2, a poppet valve 18 is movably disposed within each intake port 14 of the cylinder head 12 and controls the flow of fuel and air entering the combustion chamber 10. The poppet valve is selectively movable from a closed position in which the valve engages the valve seat 20 to an open position (shown in phantom in FIG. 2) in which the valve is removed from the valve seat 20 to allow fuel and air to enter the combustion chamber/face 10. Similar poppet valves (not shown) are disposed within each exhaust port 16 and operate in a like manner to the poppet valves 18 to allow products of combustion to exit the combustion chamber/face 10.

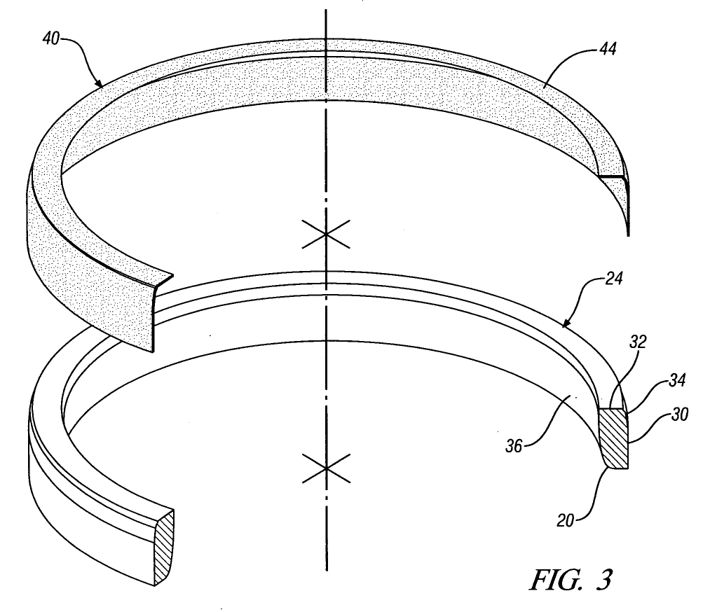

The cylinder head 12 includes integrally formed pockets or cavities 22 that are each configured to receive a valve seat insert 24. The pockets or cavities 22 are formed around or circumscribe the intake ports 14 (and exhaust ports 16) and include an insert bearing shoulder 26 and an outer or annular wall 28. Referring to FIGS. 2 and 3, a valve seat insert 24 is generally circular or ring shaped and includes an outer annular surface 30 having a diameter which is slightly larger (0.7 um) than the diameter of the outer or annular wall 28 of the cylinder head pockets 22. The size differential between the diameters of the cylinder head pockets 22 and the valve seat inserts 24 allows for interference or “press-fit” mating between the surfaces 28 and 30. Specifically, valve seat inserts 24 are press-fit into cylinder head pockets 22 of the cylinder head 12 in a manner that is effective to cause the outer annular surface 30 of each valve seat insert to abutingly and frictionally engage associated annular wall 28 of each cylinder head pocket 22 thereby securing the valve seat insert within the combustion chamber/face 10 of the cylinder head 12.

The outer annular surface 30 of each valve seat insert 24 may include an angled or ramped portion 34 connecting it to pocket seating surface 32. The ramped portion aides in centering and guiding the insert into a cylinder head pocket 22 during the press-fitting process. Additionally, each valve seat insert 24 includes an inner annular surface 36 having an angled or ramped portion or valve seat 20 which is adapted to conformingly and sealingly receive and engage the outer sealing surface 38 of a poppet valve 18 to allow the poppet valve to selectively seal intake or exhaust port 14, 16 respectively of combustion chamber/face 10. The valve seat inserts 24 may be manufactured from a relatively durable, wear-resistant and heat treated metal material, such as hardened, heat-treated powder metal, cast steel or iron.

Referring again to FIGS. 2 and 3, in an exemplary embodiment, a carbon layer 40 is disposed on or between the surfaces 26, 28 of the insert pockets 22 of the cylinder head 12 and the corresponding or opposing surfaces 30, 32, 34 of the valve seat inserts 24, or a combination thereof. In one embodiment the carbon layer 40 is a graphitic carbon, amorphous carbon, diamond-like carbon or a combination thereof. The carbon layer 40 may be applied to the surfaces 26, 28 of an insert pocket 22, the surfaces 30, 32 34 of a valve seat insert 24 or may comprise a carbon pre-form 44, FIG. 3, disposed between a valve seat insert 24 and an insert pocket 22 prior to the installation of the valve seat insert 24. The carbon layer may be deposited on the various surfaces using chemical vapor deposition, physical vapor deposition, thermal spraying, painting, screen-printing, transfer printing, sooting, dip coating or any combination suitable for application of a thin layer to the surfaces (including the carbon pre-form referred to above). The carbon layer 40 functions to provide a lubricating surface that will aid the press-fit insertion of the valve seat inserts 24 into the insert pockets 22. In addition, the carbon layer 40 operates to effectively seal and/or modify the surfaces 26, 28 of the insert pockets 22 from exposure to alcohol based fuels such as ethanol, water dissolved in the fuel or both which may become trapped in gaps or spaces, such as at 42, between the valve seat inserts 24 and the insert pockets 22. The carbon layer 40 acts to provide an improvement in the surface characteristics of the insert pocket 22 and the valve seat insert 24 materials in that it will enhance resistance to corrosion via the formation of an impervious or semi-impervious protective layer (e.g. seal) that will operate to slow or prevent a chemical attack caused by the corrosive media present by either excluding such media from the gaps or spaces, such as at 42, between the valve seat inserts 24 and the insert pockets 22 or, by reducing the quantity of such corrosive media that may enter such locations. Additionally, the carbon layer 40 may affect changes in the surfaces of the insert pockets 22 and the inserts 24 that will repel or diminish the presence, the availability or the chemical activity of the various chemical or corrosive attack sites on the materials such as changes in the wetting angle of fluids against the surface. Carbon is highly temperature tolerant and will not impede the function of devices such as oxygen sensors and the like which may operates downstream of the combustion chamber/face, allowing far more flexibility in application of the coating that is tolerable in the case of epoxy or phenolic based sealants.

While the invention has been described with reference to exemplary embodiments, it will be understood by those skilled in the art that various changes may be made and equivalents maybe substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A cylinder head assembly for an internal combustion engine, comprising:
a cylinder head having a combustion chamber/face;
a port opening into the combustion chamber/face;
an insert pocket circumferentially disposed about the port;
a valve seat insert disposed within the insert pocket; and
carbon disposed between the insert pocket and the valve seat insert and configured to establish a fuel seal/modifier between the insert pocket and the valve seat insert.

2. The cylinder head assembly of claim 1, wherein the carbon comprises a carbon layer disposed between the insert pocket and the valve seat insert.

3. The cylinder head assembly of claim 1, wherein the carbon layer is disposed on a surface of the insert pocket.

4. The cylinder head assembly of claim 3, wherein the surface of the insert pocket comprises an insert bearing shoulder and an annular wall, and wherein the carbon layer is disposed onto the insert bearing shoulder or the annular wall, or a combination thereof.

5. The cylinder head of claim 1, wherein the carbon layer is disposed onto an outer surface of the valve seat insert.

6. The cylinder head of claim 1, wherein the surface of the valve seat insert comprises an annular outer surface and a pocket bearing surface, and wherein the carbon layer is disposed onto the pocket bearing surface or the annular outer surface, or a combination thereof.

7. The cylinder head assembly of claim 1, wherein the carbon layer comprises a first carbon layer portion that is disposed onto an outer surface of the valve seat insert and a second carbon layer portion that is disposed onto a surface of the insert pocket.

8. The cylinder head assembly of claim 1, wherein the carbon comprises graphitic carbon, amorphous carbon, diamond-like carbon or, a combination thereof.

9. The cylinder head assembly of claim 1, wherein the carbon comprises a carbon preform disposed between the valve seat insert and the insert pocket.

10. A method of manufacturing a corrosion resistant cylinder head for an internal combustion engine comprising:
forming a cylinder head having a combustion chamber/face and a port opening into the combustion chamber/face;
forming an insert pocket about the port of the cylinder head;
forming a valve seat insert;
fixing the valve seat insert into the insert pocket; and
disposing carbon between the valve seat insert and the insert pocket such that the valve seat insert bears upon the carbon to form a fuel seal/surface modifier between the valve seat insert and the insert pocket.

11. The method of claim 10, further comprising:
forming a carbon preform; and
inserting the carbon preform between the valve seat insert and the insert pocket prior to fixing the valve seat insert into the insert pocket.

12. The method of claim 10, further comprising depositing a carbon layer on a surface of the valve seat insert or on a surface of the insert pocket.

13. The method of claim 12, wherein the surface of the insert pocket comprises an insert bearing shoulder and an annular wall, and wherein the carbon layer is deposited onto the insert bearing shoulder or the annular wall, or a combination thereof.

14. The method of claim 12, wherein depositing the carbon layer comprises:
depositing a first carbon layer portion onto an outer surface of the valve seat insert; and
depositing a second carbon layer portion onto a surface of the insert pocket.

15. The method of claim 12, wherein depositing the carbon layer comprises chemical vapor deposition, physical vapor deposition, thermal spraying, painting, screen-printing, transfer printing, sooting or dip coating, or any combination thereof.

16. The method of claim 12, wherein the carbon comprises graphitic carbon, amorphous carbon, diamond-like carbon or, a combination thereof.
